(19) United States
(12) Patent Application Publication
(10) Pub. No.: US 2026/0107984 A1
(43) Pub. Date: Apr. 23, 2026

(54) CONTROL ASSEMBLY FOR AEROSOL GENERATING DEVICE

(71) Applicant: Imperial Tobacco Limited, Bristol Avon (GB)

(72) Inventors: Joseph Pemberton, Bristol Avon (GB); Andrew Robert Wallace, Bristol Avon (GB)

(21) Appl. No.: 19/103,801

(22) PCT Filed: Aug. 24, 2023
(86) PCT No.: PCT/EP2023/073295

§ 371 Date: Feb. 13, 2025

(30) Foreign Application Priority Data
Aug. 31, 2022 (EP) 22193262.7

(51) Int. Cl. A24F 40/60; A24F 40/40; A24F 40/50; H01H 13/14

(52) U.S. Cl. CPC A24F 40/60; A24F 40/40; A24F 40/50; H01H 13/14

(57) ABSTRACT

The present disclosure provides a control assembly (100) for an aerosol generating device (1), the control assembly comprising: a printed circuit board (110); a button (120) moveable between a first position and a second position and configured to be brought into mechanical contact with a push switch (130), the push switch being electrically connected to the printed circuit board; and one or more button-support mechanisms (140, 142) in mechanical contact with the button, wherein: each of the one or more button-support mechanisms is mechanically biased to maintain mechanical contact with the button when the button is moved by a user between the first position and the second position; and at least one of the one or more button-support mechanisms forms an electrical grounding pathway between the button and the printed circuit board.

This application claims priority from EP22193262.7 filed 31 Aug. 2022, the contents and elements of which are herein incorporated by reference for all purposes.

### FIELD

The present disclosure relates to a control assembly for an aerosol generating device.

### BACKGROUND

A typical aerosol generating apparatus may comprise a power supply, an aerosol generating unit that is driven by the power supply, an aerosol precursor, which in use is aerosolised by the aerosol generating unit to generate an aerosol, and a delivery system for delivery of the aerosol to a user.

A drawback with known aerosol generating devices is that, when a user picks up the aerosol generating device, electrostatic discharge may pass from the user into the aerosol generating device which may cause the device to malfunction, for example via damage to electronic components of the device.

Hence, despite the effort already invested in the development of aerosol generating apparatuses/systems further improvements are desirable.

### SUMMARY OF THE INVENTION

The present disclosure provides a control assembly for an aerosol generating device, the control assembly comprises a printed circuit board; a button moveable between a first position and a second position and configured to be brought into mechanical contact with a push switch, the push switch being electrically connected to the printed circuit board; and one or more button-support mechanisms in mechanical contact with the button, wherein: each of the one or more button-support mechanisms is mechanically biased to maintain mechanical contact with the button when the button is moved by a user between the first position and the second position; and at least one of the one or more button-support mechanisms forms an electrical grounding pathway between the button and the printed circuit board.

In this way, an electrical grounding pathway between the button and the printed circuit board may be maintained when the button is moved by a user from the first position to the second position such that any electrostatic discharge originating from the user may safely flow to a ground of the printed circuit board through the one or more button-support mechanisms. If electrostatic discharge were to flow through the push switch, it may cause damage to the push switch and/or printed circuit board.

Electrical contact may be understood to mean contact between two components such that current can flow between the two components. Mechanical contact may be understood to mean contact between two components such that a contact force is generated between the two components. The button being configured to be brought into mechanical contact with the push switch may include the button being in permanent mechanical contact with the push switch. It may also include there being an air gap between the button and the push switch. For example, when a user moves the button from the first position to the second position, the button may first move through the air gap before making mechanical contact with the push switch.

In some examples, when the button is in the first position, the push switch is in an off state and, when the button is in the second position, the push switch is in an on state. In some examples, when the button is in the first position, the push switch is in an on state and, when the button is in the second position, the push switch is in an off state. Optionally, in the absence of user interaction, the button may naturally adopt an elevated position relative to the circuit board. This may result in the push switch naturally adopting an off state in the absence of user interaction. In the first position, the button may adopt an elevated position relative to the printed circuit board. Such that, when a user moves the button to the second position, the displacement between the button and the printed circuit board decreases.

In some examples, the push switch is electrically connected to a microcontroller. In some examples, the microcontroller is configured to perform predetermined functions according to predetermined inputs or input sequences to the push switch. For example, the microcontroller may perform different functions depending on the length of time the push switch has existed in a certain state for. In another example, the microcontroller may perform a particular function when a sequence of inputs is made by a user with the push switch. For example, a sequence of longer and shorter presses by the user. The microcontroller may use the state of the push switch, including the variation of the state of the push switch with time to determine which function to perform. The function may be further defined by other variables, for example the current state of the device/microcontroller. In further examples, the other variables may include the time of day.

The term state may be understood to mean a physical configuration. For example, a push switch may have two states, an on state where current can flow through the switch and an off state where current cannot flow through the switch. In some examples, the microcontroller is configured to determine the state of the push switch as a function of time. In some examples, the push switch may have two states, a first state where current flows through a first circuit and a second state where current flows through a second circuit different to the first circuit. The microcontroller may be connected to the first and second circuits, both of which may be monitored by the microcontroller to determine when a user presses the button and hence when the push switch is transitioned between states.

In some examples, the one or more button-support mechanisms are each mechanically biased to adopt an elongated state. In this way, the one or button-support mechanisms may maintain improved mechanical contact with the button as it moves between the first position and the second position. In this way, the one or more button-support mechanisms may bias the button to adopt an elevated position relative to the printed circuit board.

In some examples, the one or more button-support mechanisms each include a first cylinder and a second cylinder wherein the first cylinder is configured to slide within the second cylinder. In this way, the one or more button-support mechanisms may be manufactured at a reduced cost. In some examples, an external surface of the second cylinder may conform to an internal surface of the first cylinder. Such that, the second cylinder may be constrained to move along a central axis of the first cylinder. In some examples, the maximum and minimum displacement of the first cylinder relative to the second cylinder may be constrained by stops located within the first cylinder. The term stop may be understood to mean a piece of material designed to make contact with a component in order to constrain movement of the component. In this way, ease of assembly of the one or more button-support mechanisms may be improved. For example, as the risk of the first cylinder becoming separated from the second cylinder may be reduced.

In some examples, the one or more button-support mechanisms are each mechanically biased by a respective one or more springs. In this way, the one or more button-support mechanisms may be manufactured at a reduced cost. In some examples, the one or more springs are positioned within the first cylinder. Optionally, between a base of the first cylinder and a base of the second cylinder. In this way, biasing performance of the one or more button-support mechanisms may be improved.

In some examples, any or all of the one or more button-support mechanisms is a pogo pin. In this way, the cost and/or complexity of the control assembly may be reduced because pogo pins may be mass-produced at a reduced cost. A pogo pin is a term of the art and is understood to mean a spring-loaded pin that is a type of electrical connector mechanism.

In some examples, the control assembly further comprises a retention guide attached to the printed circuit board and in mechanical contact with the button such that the movement of the button relative to the printed circuit board is constrained along a single axis. In this way, lateral movement of the button may be prevented which may result in improved usability and/or perceived usability by a user. The retention guide may be implemented in a variety of ways. For example, the retention guide could be a structure that generally conforms to an external perimeter of the button, thus constraining the movement of the button along a single axis and/or preventing lateral movement. For example, the retention guide could be one or more pins along which the button can slide, thus constraining the movement of the button to a single axis and/or preventing lateral movement.

The term attached may be understood to mean both directly attached and indirectly attached. In one example, the retention guide may be directly attached to the circuit board. For example, by one or more screws, adhesive and/or one or more clips. Alternatively, the retention guide may be indirectly attached to the circuit board. For example, via one or more intermediatory components. For example, if the control assembly were implemented in an aerosol generating device, the retention guide may be attached to a chassis of the aerosol generation device. The printed circuit board may also be attached to the chassis of the aerosol generation device. Such that the retention guide may be considered to be indirectly attached to the printed circuit board via the chassis of the aerosol generation device.

In some examples, the retention guide limits a maximum displacement of the button relative to the printed circuit board. In this way, the button may be prevented from becoming completely separated from the control assembly. In some examples, the minimum displacement of the button relative to the printed circuit board may be limited. In one example, the minimum displacement of the button relative to the printed circuit board may be limited by the minimum displacement of the push switch relative to the printed circuit board. In another example, the minimum displacement of the button relative to the printed circuit board may be limited by the minimum displacement of the one or more button-support mechanisms relative to the printed circuit board.

In some examples, the button includes a projection that is configured to be brought into mechanical contact with the push switch. In this way, the consistency of activation of the push switch may be improved. For example, by ensuring the button makes contact with the push switch over a predetermined and predictable area of the push switch. It may also mean that the button may be made more compact, for example, by reducing the amount of material that is configured to be brought into contact with the push switch.

The projection being configured to be brought into mechanical contact with the push switch may include the projection being in permanent mechanical contact with the push switch. It may also include there being an air gap between the projection and the push switch. Such that when a user moves the button, the projection first moves through the air gap before making mechanical contact with the push switch.

In some examples, the one or more button-support mechanisms make mechanical contact with a first surface of the button and the projection extends from the first surface of the button. In this way, the stability and/or reliability of the button may be improved. For example, by increasing the support offered by the one or more button-support mechanisms to the projection.

In some examples, the control assembly comprises a plurality of button-support mechanisms. In this way, the stability of the button may be improved. For example, by providing button-support mechanisms to multiple locations on the button.

In some examples, at least two of the plurality of button-support mechanisms each respectively form a separate electrical grounding pathway between the button and the printed circuit board. In this way, the reliability of the control assembly may be improved. For example, the reliability may be improved by introducing redundancy in the electrical grounding pathway between the button and the printed circuit board. For example, if the grounding pathway formed by a first button-support mechanism was lost, then there may still be another grounding pathway formed by a second button-support mechanism available. For example, to allow electrostatic discharge to flow from the button to a ground of the printed circuit board thus potentially improving the reliability of the device.

In some examples, a first of the plurality of button-support mechanisms is positioned on a first side of the push switch and a second of the plurality of button-support mechanisms is positioned on a second side of the push switch wherein the first side and the second side are on opposing sides of the push switch. In this way, the mechanical stability of the button may be improved. For example, by providing an even distribution of support on either side of the push switch. By evenly distribution the button-support mechanisms on either side of the push switch, rotation of the button caused by non-symmetric user pressure may be supressed. The plurality of button-support mechanisms may not necessarily be attached to the push switch but instead, for example, may be located adjacent to various sides of the push switch. In this way, the term positioned on a side of the push switch may be understood to also mean located adjacent a side of the push switch.

In some examples, the plurality of button-engaging mechanisms are distributed symmetrically relative to a user-engageable surface of the button. A user-engageable surface of the button may be understood to mean a surface that the user makes contact with when the user is interacting with the button. For example, in order to activate the push switch.

In some examples, the button is electrically conductive. In this way, electrostatic discharge originating from a user may more easily flow through the button and through the one or more button-support mechanisms to a ground of the printed circuit board. For example, when the user makes contact with the button. It should be noted that the button may optionally be made to be electrically conductive in a variety of ways. For example, the button could be made of a combination of materials, at least one being electrically conductive. If the button is electrically conductive, an electrical connection may be formed between the one or more button-support mechanisms and a surface of the button. For example, a surface of the button with which a user makes contact. For example, when holding a device comprising the control assembly and/or when engaging the button.

The present disclosure also provides an aerosol generating device comprising a control assembly according to the present disclosure. In this way, an electrical grounding pathway between the button and the printed circuit board may be maintained when the button is moved by a user from the first position to the second position such that any electrostatic discharge originating from the user may safely flow to a ground of the printed circuit board through the one or more button-support mechanisms. In this way, the risk of electrostatic discharge damaging one or more components of the aerosol generating device may be reduced. The control assembly may be used to control various aspects of the aerosol generating device. In some examples, a predetermined pattern of button actuations is used to control the aerosol generating device to perform a predetermined function. In this way, the aerosol generating apparatus may be controlled in a variety of ways through a single control assembly. In some examples, the aerosol generating device includes a plurality of control assemblies according to the present disclosure. In some examples, a specific combination of button actuations across different control assemblies is used to control the aerosol generating device to perform a specific function. In this way, the aerosol generating device may be controlled more quickly.

In some examples, the aerosol generating device further comprises a power supply wherein a ground of the power supply is connected to a ground of the printed circuit board. In this way, any electrostatic discharge originating from a user may flow through the one or more button-support mechanisms and to a ground of the power supply. Thus potentially reducing the likelihood of damage being caused to the aerosol generating device by electrostatic discharge.

In some examples, the aerosol generating device further comprises a housing through which the button is located, wherein the housing is an electrical insulator. In this way, the button may provide a pathway to a ground of the printed circuit board. For example, to allow electrostatic discharge from a user to be dissipated in a safe manner.

In some examples, the aerosol generating device further comprises a housing through which the button is located, wherein the housing is an electrical conductor. The housing may include an electrical grounding pathway to the printed circuit board. The housing may include an electrical grounding pathway to a ground of the power supply. In this way, the device may include multiple electrical grounding pathways between user-interactable surfaces of the device and a ground of the printed circuit board and/or a ground of the power supply. This may result in increased device protection against electrostatic discharge.

The preceding summary is provided for purposes of summarizing some examples to provide a basic understanding of aspects of the subject matter described herein. Accordingly, the above-described features should not be construed to narrow the scope or spirit of the subject matter described herein in any way. Moreover, the above and/or proceeding examples may be combined in any suitable combination to provide further examples, except where such a combination is clearly impermissible or expressly avoided. Other features, aspects, and advantages of the subject matter described herein will become apparent from the following text and the accompanying drawings.

### BRIEF DESCRIPTION OF THE DRAWINGS

Aspects, features and advantages of the present disclosure will become apparent from the following description of examples in reference to the appended drawings in which like numerals denote like elements.

FIG. 1 is a block system diagram showing an example aerosol generating apparatus.

FIG. 2 is a block system diagram showing an example implementation of the apparatus of FIG. 1, where the aerosol generating apparatus is configured to generate aerosol from a solid precursor.

FIG. 3 is a schematic diagram showing an example implementation of the apparatus of FIG. 2.

FIG. 4 is a schematic diagram showing an example implementation of a control assembly according to the present disclosure.

FIG. 5 is a schematic diagram showing a top view of the example implementation of the control assembly of FIG. 4.

FIG. 6 is a schematic diagram showing where the example implementation of the control assembly of FIG. 4 is located within the example aerosol generating device of FIG. 3.

FIG. 7 is a rendering showing an example implementation of a control assembly according to the present disclosure.

FIG. 8 is a rendering showing an example implementation of a button-support mechanism according to the present disclosure.

### DETAILED DESCRIPTION OF THE EMBODIMENTS

Before describing several examples implementing the present disclosure, it is to be understood that the present disclosure is not limited by specific construction details or process steps set forth in the following description and accompanying drawings. Rather, it will be apparent to those skilled in the art having the benefit of the present disclosure that the systems, apparatuses and/or methods described herein could be embodied differently and/or be practiced or carried out in various alternative ways. Unless otherwise defined herein, scientific and technical terms used in connection with the presently disclosed inventive concept(s) shall have the meanings that are commonly understood by those of ordinary skill in the art, and known techniques and procedures may be performed according to conventional methods well known in the art and as described in various general and more specific references that may be cited and discussed in the present specification.

Any patents, published patent applications, and non-patent publications mentioned in the specification are hereby incorporated by reference in their entirety.

All examples implementing the present disclosure can be made and executed without undue experimentation in light of the present disclosure. While particular examples have been described, it will be apparent to those of skill in the art that variations may be applied to the systems, apparatus, and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

The use of the term “a” or “an” in the claims and/or the specification may mean “one,” as well as “one or more,” “at least one,” and “one or more than one.” As such, the terms “a,” “an,” and “the,” as well as all singular terms, include plural referents unless the context clearly indicates otherwise. Likewise, plural terms shall include the singular unless otherwise required by context.

The use of the term “or” in the present disclosure (including the claims) is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used in this specification and claim(s), the words “comprising,”having,” “including,” or “containing” (and any forms thereof, such as “comprise” and “comprises,” “have” and “has,” “includes” and “include,” or “contains” and “contain,” respectively) are inclusive or open-ended and do not exclude additional, unrecited elements or method steps.

Unless otherwise explicitly stated as incompatible, or the physics or otherwise of the embodiments, examples, or claims prevent such a combination, the features of examples disclosed herein, and of the claims, may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of example(s), embodiment(s), or dependency of claim(s). Moreover, this also applies to the phrase “in one embodiment,” “according to an embodiment,” and the like, which are merely a stylistic form of wording and are not to be construed as limiting the following features to a separate embodiment to all other instances of the same or similar wording. This is to say, a reference to ‘an,’ ‘one,’ or ‘some’ embodiment(s) may be a reference to any one or more, and/or all embodiments, or combination(s) thereof, disclosed. Also, similarly, the reference to “the” embodiment may not be limited to the immediately preceding embodiment. Further, all references to one or more embodiments or examples are to be construed as non-limiting to the claims.

The present disclosure may be better understood in view of the following explanations, wherein the terms used that are separated by “or” may be used interchangeably:

As used herein, an “aerosol generating apparatus” (or “electronic(e)-cigarette”) may be an apparatus configured to deliver an aerosol to a user for inhalation by the user. The apparatus may additionally/alternatively be referred to as a “smoking substitute apparatus”, if it is intended to be used instead of a conventional combustible smoking article. As used herein a combustible “smoking article” may refer to a cigarette, cigar, pipe or other article, that produces smoke (an aerosol comprising solid particulates and gas) via heating above the thermal decomposition temperature (typically by combustion and/or pyrolysis). An aerosol generated by the apparatus may comprise an aerosol with particle sizes of 0.2 to 7 microns, or less than 10 microns, or less than 7 microns. This particle size may be achieved by control of one or more of: heater temperature; cooling rate as the vapour condenses to an aerosol; flow properties including turbulence and velocity. The generation of aerosol by the aerosol generating apparatus may be controlled by an input device. The input device may be configured to be user-activated, and may for example include or take the form of an actuator (e.g. actuation button) and/or an airflow sensor.

Each occurrence of the aerosol generating apparatus being caused to generate aerosol for a period of time (which may be variable) may be referred to as an “activation” of the aerosol generating apparatus. The aerosol generating apparatus may be arranged to allow an amount of aerosol delivered to a user to be varied per activation (as opposed to delivering a fixed dose of aerosol), e.g. by activating an aerosol generating unit of the apparatus for a variable amount of time, e.g. based on the strength/duration of a draw of a user through a flow path of the apparatus (to replicate an effect of smoking a conventional combustible smoking article).

The aerosol generating apparatus may be portable. As used herein, the term “portable” may refer to the apparatus being for use when held by a user.

As used herein, an “aerosol generating system” may be a system that includes an aerosol generating apparatus and optionally other circuitry/components associated with the function of the apparatus, e.g. one or more external devices and/or one or more external components (here “external” is intended to mean external to the aerosol generating apparatus). As used herein, an “external device” and “external component” may include one or more of a: a charging device, a mobile device (which may be connected to the aerosol generating apparatus, e.g. via a wireless or wired connection); a networked-based computer (e.g. a remote server); a cloud-based computer; any other server system.

An example aerosol generating system may be a system for managing an aerosol generating apparatus. Such a system may include, for example, a mobile device, a network server, as well as the aerosol generating apparatus.

As used herein, an “aerosol” may include a suspension of precursor, including as one or more of:

solid particles; liquid droplets; gas. Said suspension may be in a gas including air. An aerosol herein may generally refer to/include a vapour. An aerosol may include one or more components of the precursor.

As used herein, a “precursor” may include one or more of a: liquid; solid; gel; loose leaf material; other substance. The precursor may be processed by an aerosol generating unit of an aerosol generating apparatus to generate an aerosol. The precursor may include one or more of: an active component; a carrier; a flavouring. The active component may include one or more of nicotine; caffeine; a cannabidiol oil; a non-pharmaceutical formulation, e.g. a formulation which is not for treatment of a disease or physiological malfunction of the human body. The active component may be carried by the carrier, which may be a liquid, including propylene glycol and/or glycerine. The term “flavouring” may refer to a component that provides a taste and/or a smell to the user. The flavouring may include one or more of: Ethylvanillin (vanilla); menthol, Isoamyl acetate (banana oil); or other. The precursor may include a substrate, e.g. reconstituted tobacco to carry one or more of the active component; a carrier; a flavouring.

As used herein, a “storage portion” may be a portion of the apparatus adapted to store the precursor. It may be implemented as fluid-holding reservoir or carrier for solid material depending on the implementation of the precursor as defined above.

As used herein, a “flow path” may refer to a path or enclosed passageway through an aerosol generating apparatus, e.g. for delivery of an aerosol to a user. The flow path may be arranged to receive aerosol from an aerosol generating unit. When referring to the flow path, upstream and downstream may be defined in respect of a direction of flow in the flow path, e.g. with an outlet being downstream of an inlet.

As used herein, a “delivery system” may be a system operative to deliver an aerosol to a user. The delivery system may include a mouthpiece and a flow path.

As used herein, a “flow” may refer to a flow in a flow path. A flow may include aerosol generated from the precursor. The flow may include air, which may be induced into the flow path via a puff by a user.

As used herein, a “puff” (or “inhale” or “draw”) by a user may refer to expansion of lungs and/or oral cavity of a user to create a pressure reduction that induces flow through the flow path.

As used herein, an “aerosol generating unit” may refer to a device configured to generate an aerosol from a precursor. The aerosol generating unit may include a unit to generate a vapour directly from the precursor (e.g. a heating system or other system) or an aerosol directly from the precursor (e.g. an atomiser including an ultrasonic system, a flow expansion system operative to carry droplets of the precursor in the flow without using electrical energy or other system). A plurality of aerosol generating units to generate a plurality of aerosols (for example, from a plurality of different aerosol precursors) may be present in an aerosol generating apparatus.

As used herein, a “heating system” may refer to an arrangement of at least one heating element, which is operable to aerosolise a precursor once heated. The at least one heating element may be electrically resistive to produce heat from the flow of electrical current therethrough. The at least one heating element may be arranged as a susceptor to produce heat when penetrated by an alternating magnetic field. The heating system may be configured to heat a precursor to below 300 or 350 degrees C, including without combustion.

As used herein, a “consumable” may refer to a unit that includes a precursor. The consumable may include an aerosol generating unit, e.g. it may be arranged as a cartomizer. The consumable may include a mouthpiece. The consumable may include an information carrying medium. With liquid or gel implementations of the precursor, e.g. an e-liquid, the consumable may be referred to as a “capsule” or a “pod” or an “e-liquid consumable”. The capsule/pod may include a storage portion, e.g. a reservoir or tank, for storage of the precursor. With solid material implementations of the precursor, e.g. tobacco or reconstituted tobacco formulation, the consumable may be referred to as a “stick” or “package” or “heat-not-burn consumable”. In a heat-not-burn consumable, the mouthpiece may be implemented as a filter and the consumable may be arranged to carry the precursor. The consumable may be implemented as a dosage or pre-portioned amount of material, including a loose-leaf product.

As used herein, an “information carrying medium” may include one or more arrangements for storage of information on any suitable medium. Examples include: a computer readable medium; a Radio Frequency Identification (RFID) transponder; codes encoding information, such as optical (e.g. a bar code or QR code) or mechanically read codes (e.g. a configuration of the absence or presents of cut-outs to encode a bit, through which pins or a reader may be inserted).

As used herein “heat-not-burn” (or “HNB” or “heated precursor”) may refer to the heating of a precursor, typically tobacco, without combustion, or without substantial combustion (i.e. localised combustion may be experienced of limited portions of the precursor, including of less than 5% of the total volume).

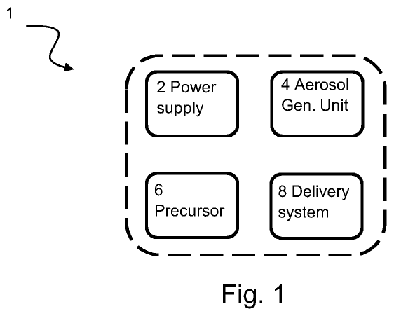

Referring to FIG. 1, an example aerosol generating apparatus 1 includes a power supply 2, for supply of electrical energy. The apparatus 1 includes an aerosol generating unit 4 that is driven by the power supply 2. The power supply 2 may include an electric power supply in the form of a battery and/or an electrical connection to an external power source. The apparatus 1 includes a precursor 6, which in use is aerosolised by the aerosol generating unit 4 to generate an aerosol. The apparatus 2 includes a delivery system 8 for delivery of the aerosol to a user.

Electrical circuitry (not shown in FIG. 1) may be implemented to control the interoperability of the power supply 4 and aerosol generating unit 6.

In variant examples, which are not illustrated, the power supply 2 may be omitted since, e.g. an aerosol generating unit implemented as an atomiser with flow expansion may not require a power supply.

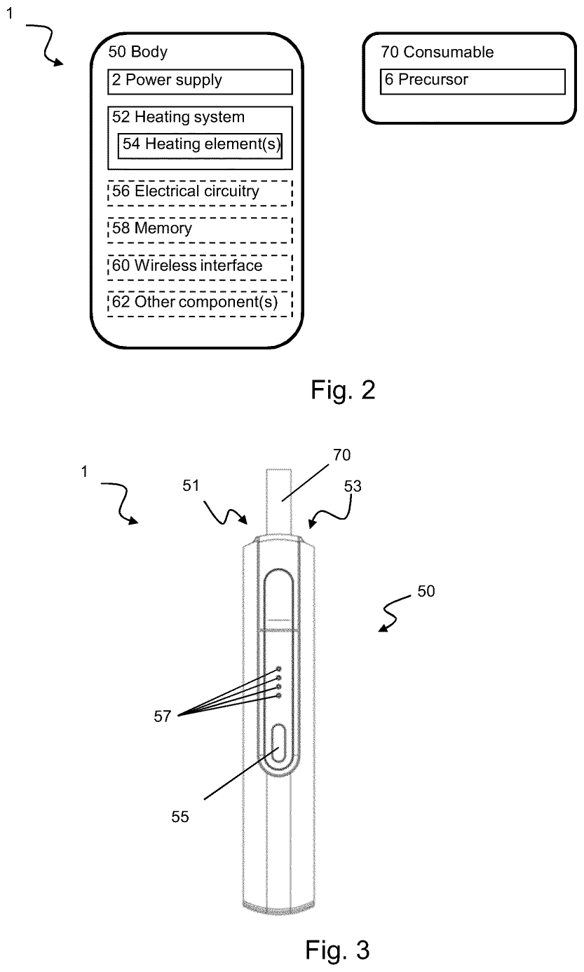

FIG. 2 shows an implementation of the apparatus 1 of FIG. 1, where the aerosol generating apparatus 1 is configured to generate aerosol by a-heat not-burn process.

In this example, the apparatus 1 includes a device body 50 and a consumable 70.

In this example, the body 50 includes the power supply 4 and a heating system 52. The heating system 54 includes at least one heating element 54. The body may additionally include any one or more of electrical circuitry 56, a memory 58, a wireless interface 60, one or more other components 62.

The electrical circuitry 56 may include a processing resource for controlling one or more operations of the body 50, e.g. based on instructions stored in the memory 58.

The wireless interface 60 may be configured to communicate wirelessly with an external (e.g. mobile) device, e.g. via Bluetooth.

The other component(s) 62 may include an actuator, one or more user interface devices configured to convey information to a user and/or a charging port, for example (see e.g. FIG. 3).

The body 50 is configured to engage with the consumable 70 such that the at least one heating element 54 of the heating system 52 penetrates into the solid precursor 6 of the consumable. In use, a user may activate the aerosol generating apparatus 1 to cause the heating system 52 of the body 50 to cause the at least one heating element 54 to heat the solid precursor 6 of the consumable (without combusting it) by conductive heat transfer, to generate an aerosol which is inhaled by the user.

FIG. 3 shows an example implementation of the aerosol generating apparatus 1 of FIG. 2.

As depicted in FIG. 3, the consumable 70 is implemented as a stick, which is engaged with the body 50 by inserting the stick into an aperture at a top end 53 of the body 50, which causes the at least one heating element 54 of the heating system 52 to penetrate into the solid precursor 6.

The consumable 70 includes the solid precursor 6 proximal to the body 50, and a filter distal to the body 50. The filter serves as the mouthpiece of the consumable 70 and thus the apparatus 1 as a whole. The solid precursor 6 may be a reconstituted tobacco formulation.

In this example, the at least one heating element 54 is a rod-shaped element with a circular transverse profile. Other heating element shapes are possible, e.g. the at least one heating element may be blade-shaped (with a rectangular transverse profile) or tube-shaped (e.g. with a hollow transverse profile).

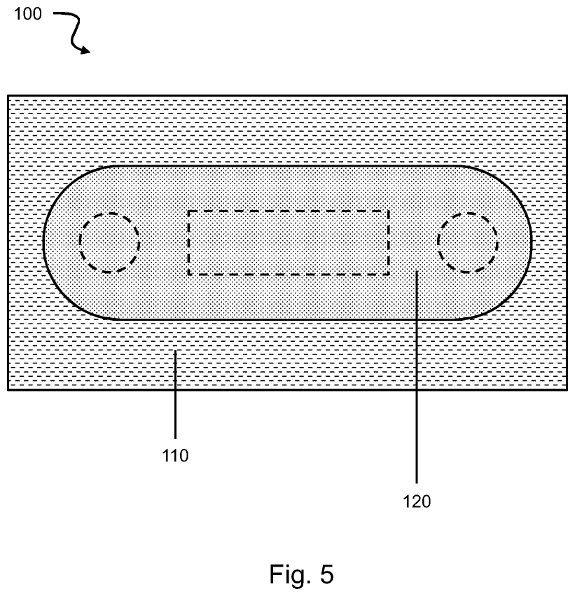

In this example, the body 50 includes a cap 51. In use the cap 51 is engaged at a top end 53 of the body 50. Although not apparent from FIG. 5, the cap 51 is moveable relative to the body 50. In particular, the cap 51 is slidable and can slide along a longitudinal axis of the body 50.

The body 50 also includes an activator 55 on an outer surface of the body 50.

The body 50 also includes a user interface device configured to convey information to a user. Here, the user interface device is implemented as a plurality of lights 57, which may e.g. be configured to illuminate when the apparatus 1 is activated and/or to indicate a charging state of the power supply 4. Other user interface devices are possible, e.g. to convey information haptically or audibly to a user.

The body may also include an airflow sensor which detects airflow in the aerosol generating apparatus 1 (e.g. caused by a user inhaling through the consumable 70). This may be used to count puffs, for example.

In this example, the consumable 70 includes a flow path which transmits aerosol generated by the at least one heating element 54 to the mouthpiece of the consumable.

In this example, the aerosol generating unit 4 is provided by the above-described heating system 52 and the delivery system 8 is provided by the above-described flow path and mouthpiece of the consumable 70.

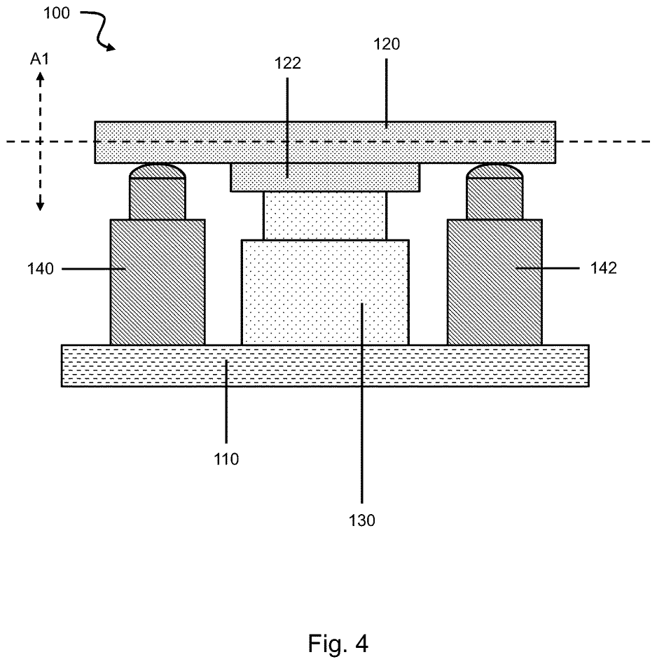

Referring to FIG. 4, a control assembly 100 for an aerosol generating device comprises a button 120, a push switch 130, a first button-support mechanism 140, a second button-support mechanism 142 and a printed circuit board 110. The button 120 is moveable between a first position (shown) and a second position (not shown). The button 120 is thereby configured to be brought into mechanical contact with the push switch 130. The push switch 130 is electrically connected to the printed circuit board 110. The first button-support mechanism 140 and the second button-support mechanism 142 are each mechanically biased to maintain mechanical contact with the button 120 when the button 120 is moved by a user between the first position (shown) and the second position (not shown). Both the first button-support mechanism 140 and the second button-support mechanism 142 are electrically conductive. Each and both of the first button-support mechanism 140 and the second button-support mechanism 142 form an electrical grounding pathway between the button 120 and the printed circuit board 110. At least a portion of the button 120 is electrically conductive, to form an electrically conductive path between a user touching the button, and at least one of the button support mechanism. In the absence of user interaction, the button 120 naturally adopts an elevated position relative to the circuit board 110.

The first button-support mechanism 140 and the second button-support mechanism 142 are each mechanically biased to adopt an elongated state. The first button-support mechanism 140 and the second button-support mechanism 142 are each mechanically biased into the elongated state by a respective spring. The first button-support mechanism 140 is a pogo pin and the second button-support mechanism 142 is a pogo pin.

A retention guide (not shown) is attached to the printed circuit board 110 and in mechanical contact with the button 120 such that the movement of the button 120 relative to the printed circuit board 110 is constrained to a single axis A1. The retention guide (not shown) limits a maximum displacement of the button 120 relative to the printed circuit board 110. The button 120 includes a projection 122 that is configured to be brought into mechanical contact with the push switch 130. In the first position (shown) the button 120 is in mechanical contact, via the projection 122, with the push switch 130. In the second position (not shown) the button 120 is in mechanical contact, via the projection 122, with the push switch 130. In the first position (shown) and the second position (not shown) the first button-support mechanism 140 is in mechanical and electrical contact with the button 120. In the first position (shown) and the second position (not shown) the second button-support mechanism 142 is in mechanical and electrical contact with the button 120. Both the first button-support mechanism 140 and the second button-support mechanism 142 make mechanical contact with a first surface of the button 120 and the projection 122 extends from the first surface of the button 120.

The first button-support mechanism 140 and the second button-support mechanism 142 each respectively form a separate electrical grounding pathway between the button 120 and the printed circuit board 110. The first button-support mechanism 140 is positioned on a first side of the push switch 130 and the second button-support mechanism 142 is positioned on a second side of the push switch 130 wherein the first side and the second side are opposing sides of the push switch 130. The button 120 is electrically conductive.

FIG. 5 shows a top view of the control assembly shown in FIG. 4. The printed circuit board 110 extends beyond the outer perimeter of the button 120. The button 120 has a generally elongate shape, with two opposing rounded ends, connected by straight sides.

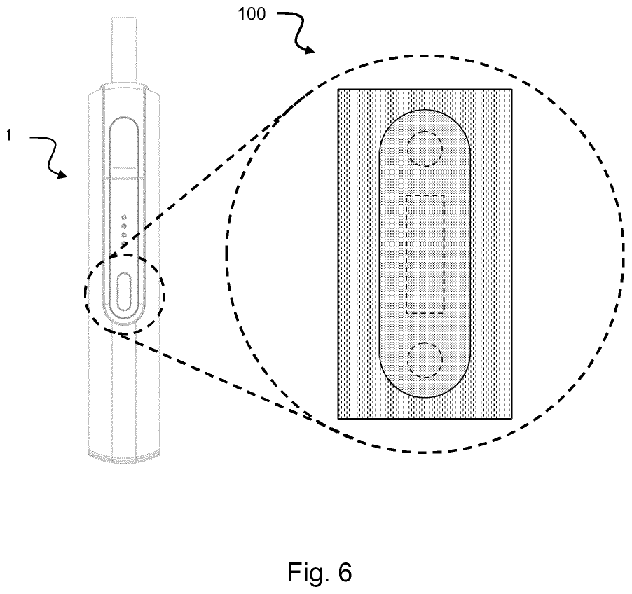

FIG. 6. shows where the control assembly shown in FIG. 4 may be located within the example aerosol generating apparatus 1 of FIG. 3. The aerosol generating apparatus 1 includes electrical circuitry 56 connected to the printed circuit board 110. The control assembly 100 is used to control various operational aspects of the aerosol generating apparatus 1. As a first example, the control assembly 100 may be used to turn on the aerosol generating apparatus 1. As a second example, the control assembly 100 may be used to turn off the aerosol generating apparatus 1. As a third example, the control assembly 100 may be used to control various aspects of operation through predetermined combinations of button presses that may optionally include predetermined time delays between button presses. As a fourth example, the control assembly 100 may be used to change an operation mode of the aerosol generating apparatus 1. The control assembly 100 may be used to commence a heating cycle of the aerosol generating apparatus 1. The control assembly 100 may be used to cause the aerosol generating apparatus 100 to heat a heater of the apparatus 100.

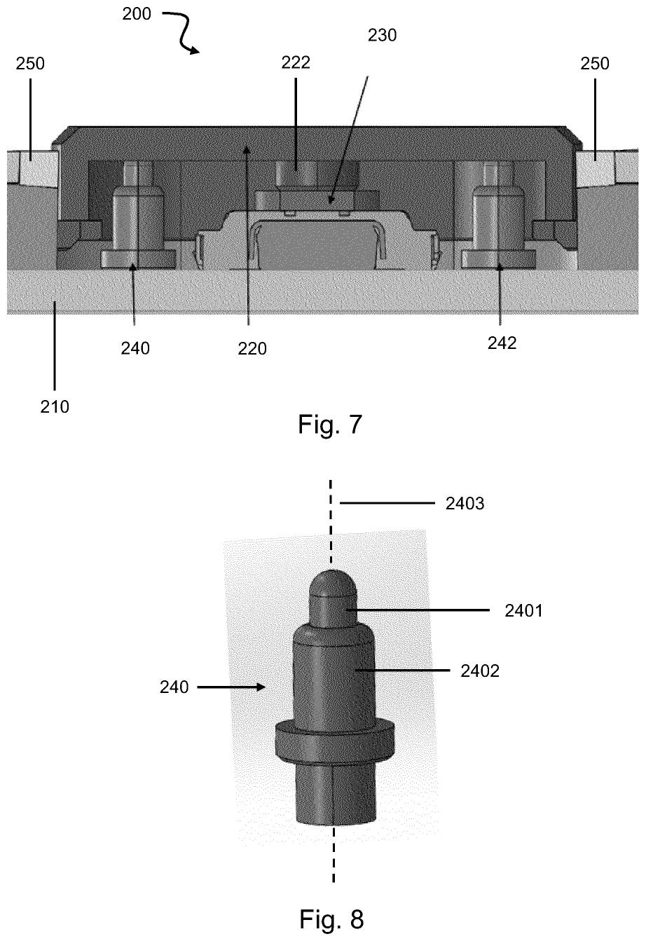

Referring to FIG. 7, a control assembly 200 for an aerosol generating device comprises a button 220, a push switch 230, a first button-support mechanism 240, a second button-support mechanism 242 and a printed circuit board 210. The button 220 is moveable between a first position (shown) and a second position (not shown) and configured to be brought into mechanical contact with the push switch 230. The push switch 230 is electrically connected to the printed circuit board 210. The first button-support mechanism 240 and the second button-support mechanism 242 are each mechanically biased to maintain mechanical contact with the button 220 when the button 220 is moved by a user between the first position (shown) and the second position (not shown).

Both the first button-support mechanism 240 and the second button-support mechanism 242 each form a respective electrical grounding pathway between the button 220 and the printed circuit board 210. In the absence of user interaction, the button 220 naturally adopts an elevated position relative to the circuit board 210. The first button-support mechanism 240 and the second button-support mechanism 242 are each mechanically biased to adopt an elongated state. The first button-support mechanism 240 and the second button-support mechanism 242 are each mechanically biased by a spring. The first button-support mechanism 240 is a pogo pin and the second button-support mechanism 242 is a pogo pin.

A retention guide 250 is attached to the printed circuit board 210 and in mechanical contact with the button 220 such that the movement of the button 220 relative to the printed circuit board 210 is constrained to a single axis. The retention guide 250 limits a maximum displacement of the button 220 relative to the printed circuit board 210. The retention guide 250 conforms to an external perimeter of the button 220. The retention guide 250 prevents lateral movement of the button 220. The button 220 includes a projection 222 that is sized and located to be brought into mechanical contact with the push switch 230. In the first position (shown) the button 220 is in mechanical contact, via the projection 222, with the push switch 230. In the second position (not shown) the button 220 is in mechanical contact, via the projection 222, with the push switch 230.

In the first position (shown) and the second position (not shown) the first button-support mechanism 240 is in mechanical and electrical contact with the button 220. In the first position (shown) and the second position (not shown) the second button-support mechanism 242 is in mechanical and electrical contact with the button 220. Both the first button-support mechanism 240 and the second button-support mechanism 242 make mechanical contact with a first surface of the button 220 and the projection 222 extends from the first surface of the button 220. The first button-support mechanism 240 and the second button-support mechanism 242 each respectively form a separate electrical grounding pathway between the button 220 and the printed circuit board 210. The first button-support mechanism 240 is positioned on a first side of the push switch 230 and the second button-support mechanism 242 is positioned on a second side of the push switch 230 wherein the first side and the second side are on opposing sides of the push switch 230. The button 220 is electrically conductive.

FIG. 8 shows the button-support mechanism 240 isolated from the control assembly of FIG. 7. The button-support mechanism 240 is a pogo pin. The button-support mechanism 240 includes a first cylinder 2401 and a second cylinder 2402 wherein the first cylinder 2401 is configured to slide within the second cylinder 2402. The first cylinder 2401 is constrained by the second cylinder 2402 to slide along a single axis 2403. A central axis of the first cylinder 2401 is aligned with a central axis of the second cylinder 2402. The button-support mechanism 240 is mechanically biased to adopt an elongated state via a spring (not shown). The spring is positioned between a base of the first cylinder 2401 and a base of the second cylinder 2402. The maximum and minimum displacement of the first cylinder 2401 relative to the second cylinder 2402 is constrained by stops.

1. A control assembly for an aerosol generating device, the control assembly comprising:
a printed circuit board;
a button moveable between a first position and a second position and configured to be brought into mechanical contact with a push switch, the push switch being electrically connected to the printed circuit board; and
one or more button-support mechanisms in mechanical contact with the button, wherein:
each of the one or more button-support mechanisms is mechanically biased to maintain mechanical contact with the button when the button is moved by a user between the first position and the second position;
at least one of the one or more button-support mechanisms forms an electrical grounding pathway between the button and the printed circuit board; and
the one or more button-support mechanisms each include a first cylinder and a second cylinder wherein the first cylinder is configured to slide within the second cylinder.

2. The control assembly according to claim 1, wherein the one or more button-support mechanisms are each mechanically biased to adopt an elongated state.

3. The control assembly according to claim 1, wherein the one or more button-support mechanisms are each mechanically biased by a respective one or more springs.

4. The control assembly according to claim 1, wherein any of the one or more button-support mechanisms is a pogo pin.

5. The control assembly according to claim 1, further comprising a retention guide attached to the printed circuit board and in mechanical contact with the button such that the movement of the button relative to the printed circuit board is constrained to a single axis.

6. The control assembly according to claim 5, wherein the retention guide limits a maximum displacement of the button relative to the printed circuit board.

7. The control assembly according to claim 1, wherein the button includes a projection that is configured to be brought into mechanical contact with the push switch.

8. The control assembly according to claim 7, wherein the one or more button-support mechanisms make mechanical contact with a first surface of the button and the projection extends from the first surface of the button.

9. The control assembly according to claim 1, comprising a plurality of button-support mechanisms.

10. The control assembly according to claim 9, wherein at least two of the plurality of button-support mechanisms each respectively form a separate electrical grounding pathway between the button and the printed circuit board.

11. The control assembly according to claim 9, wherein a first of the plurality of button-support mechanisms is positioned on a first side of the push switch and a second of the plurality of button-support mechanisms is positioned on a second side of the push switch wherein the first side and the second side are on opposing sides of the push switch.

12. The control assembly according to claim 1, wherein the button is electrically conductive.

13. An aerosol generating device comprising the control assembly according to claim 1.

14. The aerosol generating device according to claim 13, further comprising a power supply wherein a ground of the power supply is connected to a ground of the printed circuit board.

15. The aerosol generating device according to claim 13, further comprising a housing through which the button is located, wherein the housing is an electrical insulator.
